(19) United States
(12) Patent Application Publication
(10) Pub. No.: US 2002/0189073 A1
(43) Pub. Date: Dec. 19, 2002

(54) Apparatus for assembling nuts and method therefor

(76) Inventor: Neng-Shu Tseng, Taipei (TW)

Correspondence Address: BACON & THOMAS, PLLC, 625 SLATERS LANE, FOURTH FLOOR, ALEXANDRIA, VA, 22314

(21) Appl. No.: 09/875,917

(22) Filed: Jun. 8, 2001

(51) Int. Cl. B23P 11/00; B21D 39/03; B23P 17/00

(52) U.S. Cl. 29/525.02; 29/525.01; 29/799

(57) ABSTRACT

An apparatus for assembling nuts in holes of a workpiece and method therefor are provided. The method comprises the steps of transferring a row of nuts in a groove; moving fastening devices together with clamped steel cables toward the groove; moving the fastening devices to lift the steel cables to penetrate through the holes of the groove and the nuts; removing the steel cables from the groove; repeatedly lowering and opening the fastening devices for dropping the nuts onto one of clamp devices; moving a platform together with the workpiece toward an above board member having an aperture until the hole of the workpiece is aligned with the aperture of the board member; and repeatedly opening and closing the arms of the clamp device to guide the nuts through the aperture of the board member to fall into the hole of the workpiece. This can effect a high yield and reduction in cost.

### FIELD OF THE INVENTION

The present invention relates to nuts assembly and more particularly to an apparatus for assembling nuts and method therefor with improved characteristics.

### BACKGROUND OF THE INVENTION

Conventionally, the housing of an electronic product (e.g., mobile phone) has a plurality of plastic holding sockets each having a hole for receiving nut. Typically, the nut assembly process comprises the steps of clamping a nut by hand, aligning the nut with the hole, inserting the nut into the hole by hand, and melting the plastic holding socket by means of high frequency heating for securing the nut and the holding socket together. However, the previous process suffered from several disadvantages. For example, it is not easy to clamp the nut by hand since the size of nut is relatively small. Further, nut and hole may be misaligned since the view is blocked by hand. Furthermore, nut may fall outside the hole while inserting. Moreover, it is impossible to use hand to remove nut from hole for reassembly once the orientation of nut with respect to hole is found to be incorrect after assembly. As a result, the efficiency and performance of assembling such nuts onto the housing of an electronic product are very low.

### SUMMARY OF THE INVENTION

It is an object of the present invention to provide a process for assembling a plurality of nuts into holes of holding sockets on a workpiece, the process comprising the steps of: a) transferring a row of nuts in a groove wherein each nut is placed on one of a plurality of holes on the bottom of the groove; b) moving a plurality of fastening devices together with a plurality of clamped steel cables toward the groove for aligning the steel cables with the holes of the groove from below; c) moving the fastening devices to lift the steel cables to penetrate through the holes of the groove and the nuts; d) removing the steel cables from the groove by removing the fastening devices; e) lowering and opening the upper one of the fastening devices for dropping the nuts on the upper one of the fastening devices down to the lower one of the fastening devices; f) closing the upper one of the fastening devices and opening the lower one of the fastening devices for further dropping the nuts onto the upper one of a plurality of clamp devices each having two arms; g) closing the lower one of the fastening devices for clamping the steel cables again; h) moving a platform together with the workpiece toward an above board member having an aperture until the hole of holding sockets on the workpiece is aligned with the aperture of the board member; and i) repeatedly opening and closing the arms of the clamp device to guide the nuts through the aperture of the board member to fall into the hole of holding sockets on the workpiece.

It is another object of the present invention to provide an apparatus for assembling a plurality of rows of nuts in holes of holding sockets on a workpiece, the apparatus comprising a movable platform with the workpiece disposed thereon; a board member placed above the platform by a predetermined distance having an aperture aligned with the hole of holding sockets on the workpiece; a plurality of clamp devices provided longitudinally on a post adjacent to the aperture of the board member, each clamp device having two arms jointed on the post; a plurality of steel cables having one end inserted through the aperture of the board member and the other end clamped by a plurality of fastening devices each having two opposed jaws; a horizontal groove on the same side as the other ends of the steel cable with the row of nuts disposed therein; and a drive mechanism comprising a first, a second, and a third drive members; wherein the first drive member is operative to move the fastening devices together with the fastened steel cables, the steel cables are lifted to penetrate through the groove and the nuts, remove the nuts from the groove, repeatedly open and close the jaws of the fastening devices by the activation of the second drive member, lower the nuts on the upper one of the fastening device onto the topmost arms through the lower one of the fastening devices along the steel cables, repeatedly open and close the arms of the clamp device to guide the nuts through the aperture of the board member, move the platform together with the workpiece toward the board member until the hole of the holding sockets on workpiece is aligned with the aperture of the board member, and drop the nut into the hole of the holding socket on workpiece through the aperture of the board member.

The above and other objects, features and advantages of the present invention will become apparent from the following detailed description taken with the accompanying drawings.

### BRIEF DESCRIPTION OF THE DRAWINGS

FIG. 1 is a perspective view of an apparatus for assembling nuts according to the invention;

FIG. 2 is a view similar to FIG. 1 where nuts have removed from groove;

FIG. 3 is a view similar to FIG. 1 where nuts have dropped from an upper fastening device to a lower fastening device;

FIG. 4 is a view similar to FIG. 1 where lower fastening device has opened and a row of nuts are placed on groove;

FIG. 5 is a view similar to FIG. 1 where lower fastening device has closed after dropping nuts;

FIG. 6 is a side view illustrating a drive mechanism and associated components of the invention;

FIG. 7 is a perspective view illustrating the mounting of nut onto housing of an electronic device; and

FIG. 8 is a view similar to FIG. 7 where nut has mounted in the hole on the housing of electronic device.

### DETAILED DESCRIPTION OF THE PREFERRED EMBODIMENTS

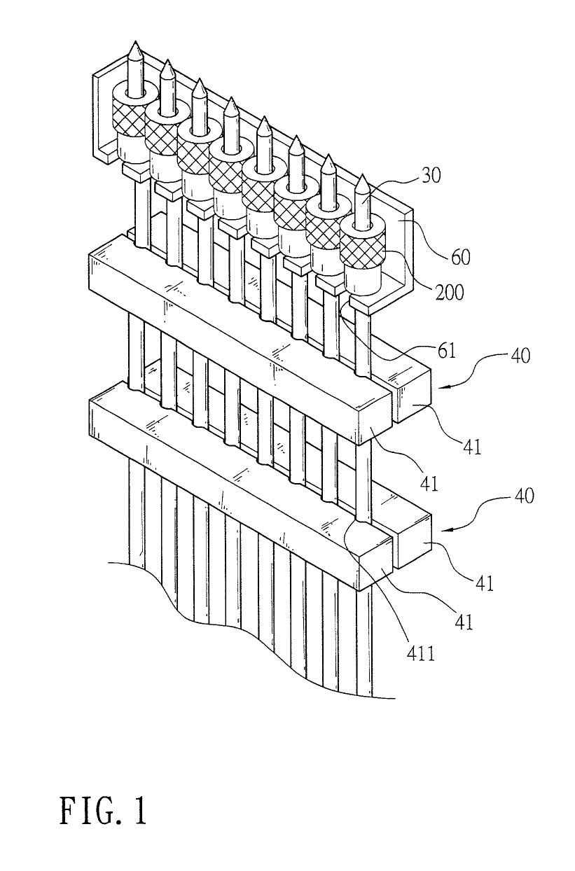

Referring to FIGS. 1 to 8, there is shown an apparatus for assembling nuts in holes of holding sockets on a workpiece in accordance with the invention. The method for assembling nuts comprises the steps of:

a) conveying a plurality of nuts 200 to a distributor (not shown), which is used for arranging nuts 200 in rows, and transferring each row of nuts 200 from the distributor to a groove 60 having slots 61 on the bottom thereof aligning with the holes of nuts 200 in a row;

b) moving a plurality of fastening devices 40 (two are shown) together with a plurality of steel cables 30 clamped by fastening devices 40 toward groove 60 for aligning steel cables 30 with groove 60 from below;

c) further moving fastening devices 40 to lift steel cables 30 to penetrate through slots 61 on the bottom of groove 60 and holes of nuts 200 (as shown in FIG. 1);

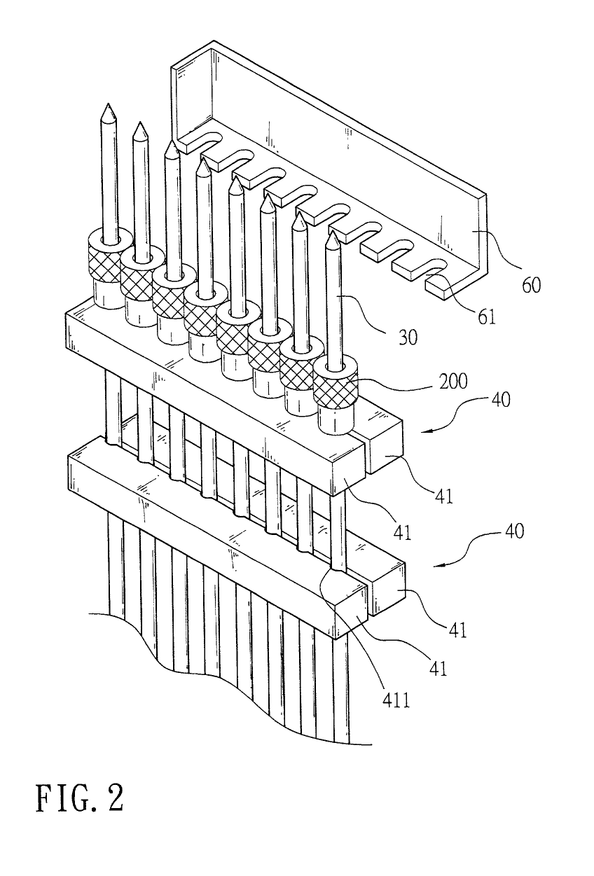

d) removing steel cables 30 from groove 60 by removing fastening devices 40 (as shown in FIG. 2);

e) lowering and opening the upper fastening device 40 for dropping nuts 200 on the upper fastening device 40 down to the lower fastening device 40;

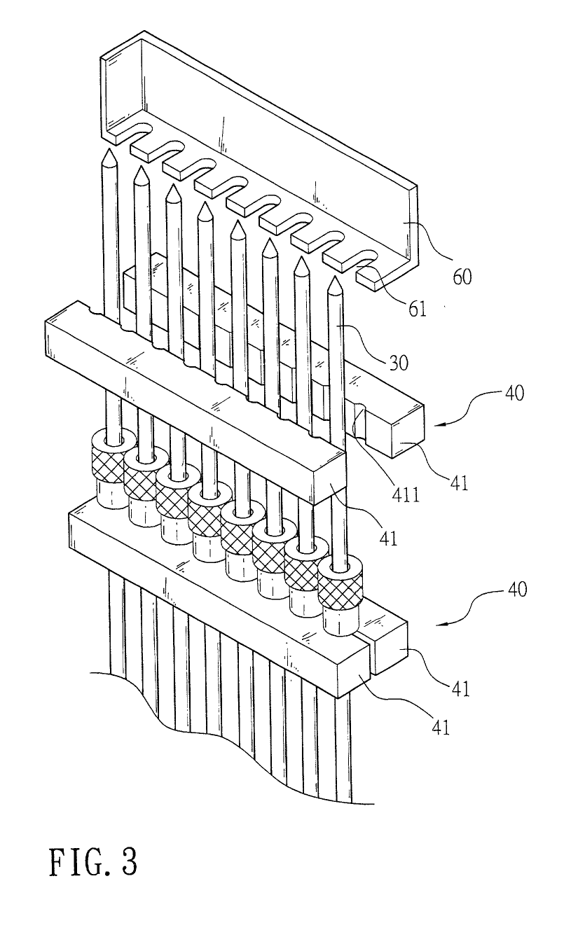

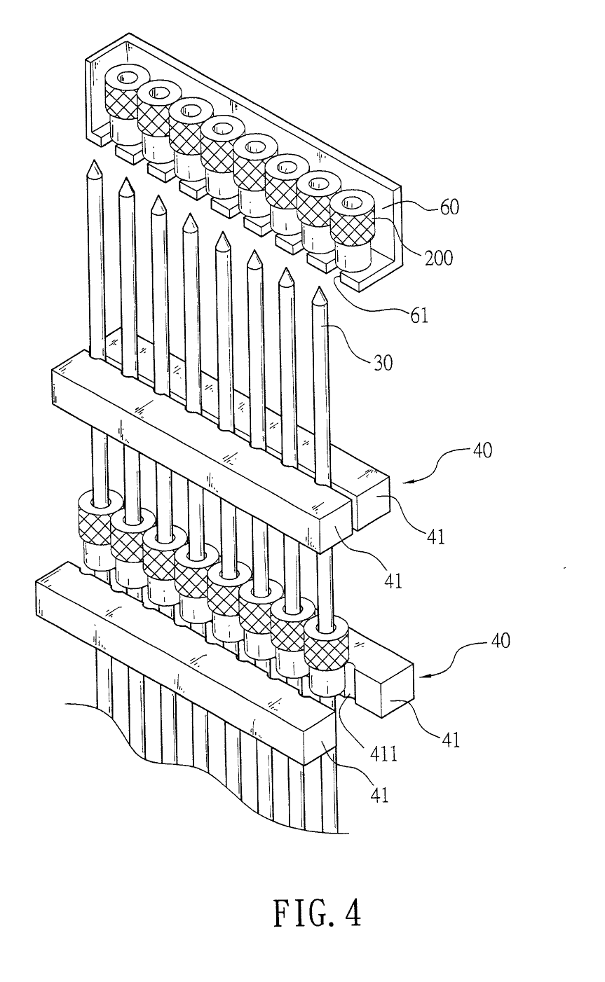

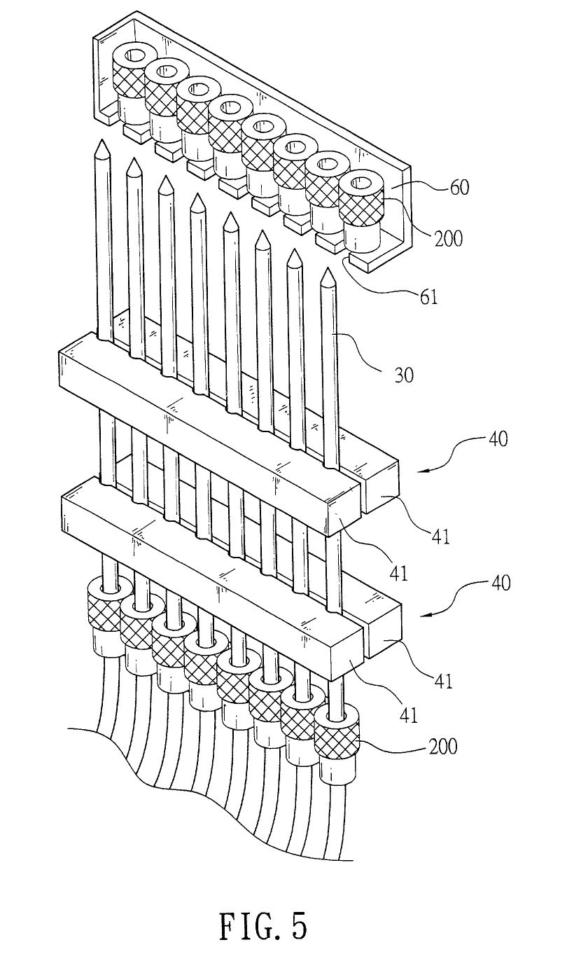

f) closing the upper fastening device 40 to clamp steel cables 30 and opening the lower fastening device 40 (as shown in FIGS. 3 and 4) for further dropping nuts 200 down (as shown in FIG. 5); and

g) closing the lower fastening device 40 for clamping steel cables 30 again (as shown in FIG. 5).

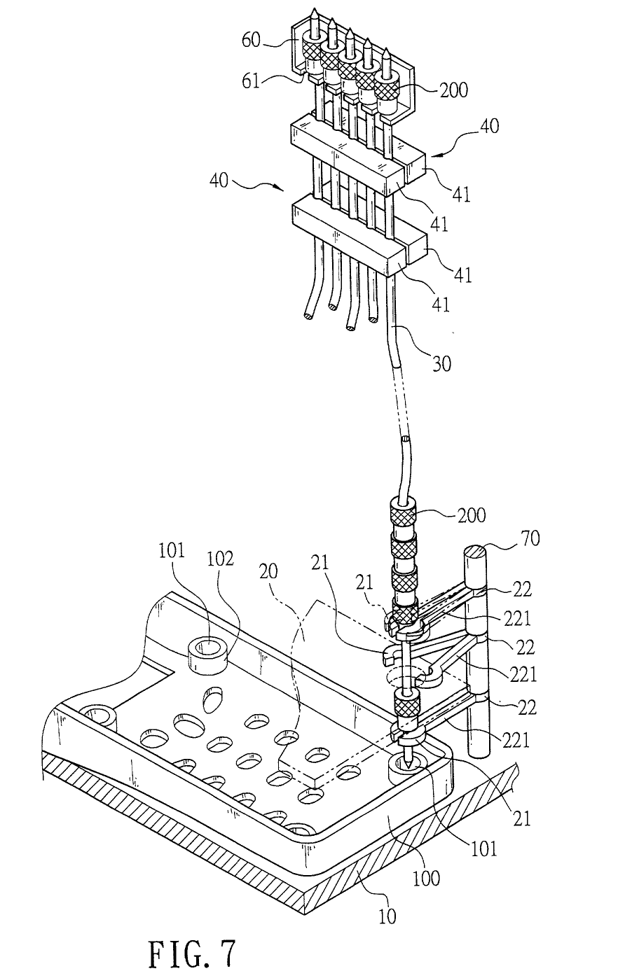

These steps may be performed continuously for inserting nuts 200 into holes 101 of holding sockets 102 on a workpiece 100 through apertures 21 on a board member 20 (as shown in FIG. 7). The advantages of the assembling method are automatic process, high in yield and reduction in cost.

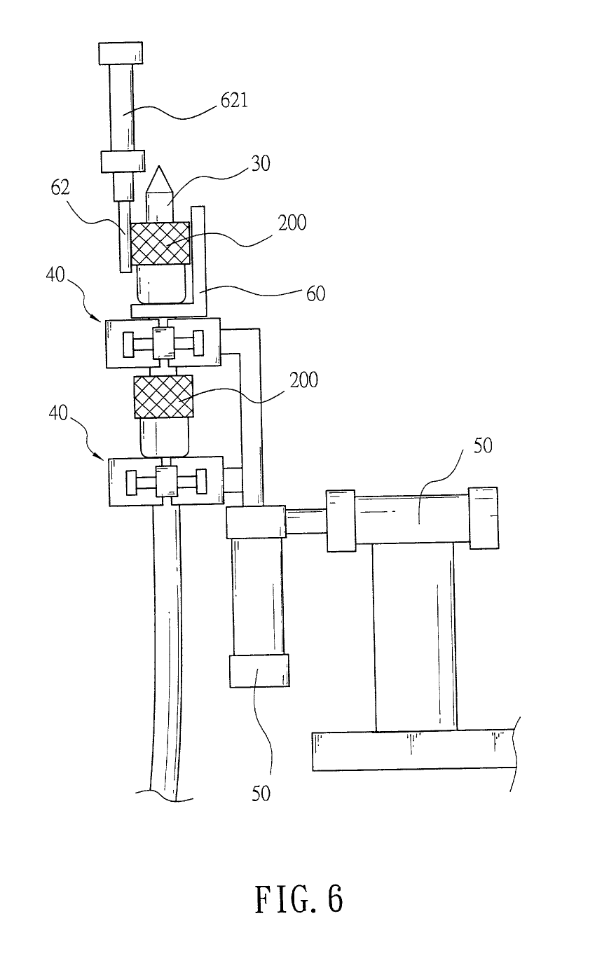

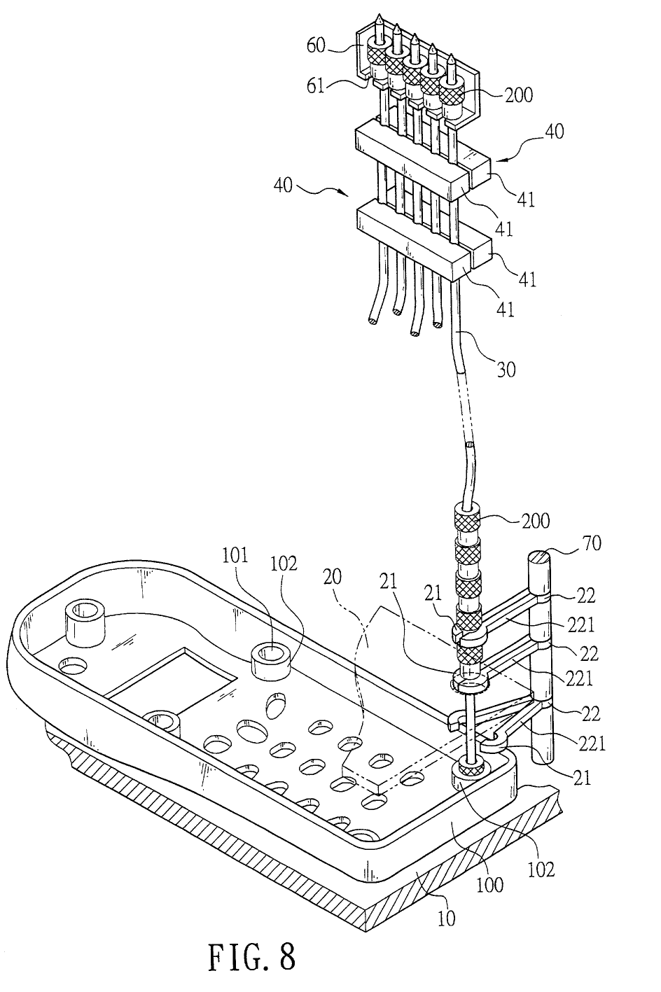

The apparatus for assembling nuts are detailed below. The apparatus is placed on a movable platform 10 (as shown in FIGS. 7 and 8). A workpiece 100 is placed on platform 10 such that workpiece 100 and platform 10 may be moved together when platform 10 is moved. A board member 20 is placed above workpiece 100 by a predetermined distance. An aperture 21 is formed on board member 20 and is aligned with hole 101 of holding socket 102 on workpiece 100. A plurality of clamp devices 22 are provided longitudinally on a post 70 adjacent to aperture 21 of board member 20. Each clamp device 22 has two arms 221 jointed on the post 70. Each arm 221 is associated with a first drive mechanism (not shown) such that arms 221 may be opened or closed by the activation of the first drive mechanism. A steel cable 30 is inserted through aperture 21 of board member 20. Steel cables 30 are clamped by a plurality of fastening devices 40 (two are shown). Each fastening device 40 has two opposed jaws 41. A plurality of equally spaced longitudinal recesses 411 are formed on jaw 41 (as shown in FIGS. 3 and 4). Hence steel cables 30 may be held firmly by the closed jaws 41. Further, jaws 41 are associated with a second drive mechanism 50 (e.g., hydraulic cylinder) such that fastening devices 40 together with steel cables 30 may be moved by the activation of the second drive mechanism 50 (as shown in FIG. 6). A horizontal groove 60 is above board member 20 by a predetermined distance. A row of slots 61 are formed on the bottom of groove 60 (as shown in FIGS. 2 and 3). A stop 62 is disposed on the open side of groove 60 (as shown in FIG. 6). Stop 62 is associated with a third drive mechanism 621. Hence, once nuts 200 have been transferred into groove 60, nuts 200 may be prevented from falling out of groove 60 by the stop 62.

In use, first place workpiece 100 on platform 10. Then activate second drive mechanism 50 to move fastening devices 40 together with the fastened steel cables 30. Then lift steel cables 30 to penetrate through the slots of groove 60 and holes of nuts 200. Next, move nuts 200 outward away from groove 60 in response to the lifting of stop 62 from the open side of groove 60 by the activation of third drive mechanism 621. Then repeatedly open and close jaws 41 of fastening devices 40 by the activation of second drive mechanism 50 (as shown in FIG. 6). Hence, nuts 200 on upper fastening device 40 may lower onto the topmost arms 221 through lower fastening device 40 along steel cables 30 (as shown in FIG. 7). Similarly, repeatedly open and close arms 221 of clamp device 22 to guide nuts 200 sleeved on steel cables 30 through aperture 21 of board member 20. At the same time, platform 10 together with workpiece 100 are moving toward board member 20 until hole 101 of holding socket on workpiece 100 is aligned with aperture 21 of board member 20. Finally, nut 200 may fall in hole 101 of holding socket on workpiece 100 through aperture 21 of board member 20. After nut 200 has been mounted in workpiece 100, platform 10 is moved to another place for subsequent processing.

While the invention has been described by means of specific embodiments, numerous modifications and variations could be made thereto by those skilled in the art without departing from the scope and spirit of the invention set forth in the claims.

What is claimed is:

1. A process for assembling a plurality of nuts in holes of holding sockets on a workpiece, said process comprising steps of:
a) transferring a row of nuts in a groove wherein each nut is placed on one of a plurality of slots on said bottom of said groove;
b) moving a plurality of fastening devices together with a plurality of clamped steel cables toward said groove for aligning said steel cables with said slots of said groove from below;
c) moving said fastening devices to lift said steel cables to penetrate through said slots of said groove and said nuts;
d) removing said steel cables from said groove by removing said fastening devices;
e) lowering and opening said upper one of said fastening devices for dropping said nuts on said upper one of said fastening devices down to said lower one of said fastening devices;
f) closing said upper one of said fastening devices to clamp said steel cables and opening said lower one of said fastening devices for further dropping said nuts onto said upper one of a plurality of clamp devices each having two arms;
g) closing said lower one of said fastening devices for clamping said steel cables again;
h) moving a platform together with said workpiece toward an above board member having an aperture until said hole of said workpiece is aligned with said aperture of said board member; and
i) repeatedly opening and closing said arms of said clamp device to guide said nuts through said aperture of said board member to fall into said hole of holding sockets on said workpiece.

2. The process of claim 1, wherein before said step a) further comprises the step of al) conveying said plurality of nuts to a distributor for arranging them in rows prior to transferring.

3. The process of claim 1, wherein said step h) is performed while said nuts are dropping through said aperture of said board member.

4. An apparatus for assembling a plurality of rows of nuts in holes of holding sockets on a workpiece, said apparatus comprising:
a movable platform with said workpiece disposed thereon;
a board member above said platform by a predetermined distance having an aperture aligned with said hole of holding sockets on said workpiece;
a plurality of clamp devices provided longitudinally on a post adjacent to said aperture of said board member, each clamp device having two arms jointed on said post;
a plurality of steel cable having one end inserted through said aperture of said board member and said other end clamped by a plurality of fastening devices each having two opposed jaws;
a horizontal groove on said same side as said other ends of said steel cable with said row of nuts disposed therein; and
a drive mechanism comprising a first, a second, and a third drive members;
wherein said first drive member is operative to move said fastening devices together with said fastened steel cables, said steel cables are lifted to penetrate through said groove and said nuts, remove said nuts from said groove, repeatedly open and close said jaws of said fastening devices by said activation of said second drive member, lower said nuts on said upper one of said fastening device onto said topmost arms through said lower one of said fastening devices along said steel cables, repeatedly open and close said arms of said clamp device to guide said nuts through said aperture of said board member, move said platform together with said workpiece toward said board member until said hole of holding socket on said workpiece is aligned with said aperture of said board member, and drop said nut into said hole of holding socket on said workpiece through said aperture of said board member.

5. The apparatus of claim 4, further comprising a stop on said open side of said groove associated with said third drive member so that once said nuts have been transferred into said groove said nuts are prevented from falling out of said groove by said stop.

6. The apparatus of claim 4, wherein each jaw has a plurality of equally spaced longitudinal recesses so that said steel cables are held firmly by said closed jaws.

7. The apparatus of claim 4, wherein said third drive member is a hydraulic cylinder.
